(19) United States
(12) Patent Application Publication
(10) Pub. No.: US 2026/0037938 A1
(43) Pub. Date: Feb. 5, 2026

(54) NETWORK ACQUISITION OF SPORTS-RELATED SERVICES

(71) Applicant: The Good Game, Inc., Lawrence, KS (US)

(72) Inventor: Mashhur Zarif Haque, Lawrence, KS (US)

(21) Appl. No.: 19/357,586

(22) Filed: Oct. 14, 2025

Related U.S. Application Data
(63) Continuation-in-part of application No. 18/233,187, filed on Aug. 11, 2023, now Pat. No. 12,468,741.

(51) Int. Cl. G06Q 20/08

(52) U.S. Cl. CPC G06Q 20/0855

(57) ABSTRACT

A sports services system may obtain sports-related data from various entities for matching the various entities across a network using statistical and machine learning algorithms to maximize an objective of the various entities. The various entities may comprise athletes, trainers, agents, parents, and sports organizations at any level. User data associated with each entity may be compared to maximize the opportunities for each entity to provide best options for sports achievements, goal realization, and career development while maintaining social and emotional health for all entities.

### BACKGROUND

This patent application is a continuation-in-part application claiming priority benefit, with regard to all common subject matter, of commonly assigned and U.S. patent application Ser. No. 18/233,187, filed Aug. 11, 2023, and entitled “NETWORK ACQUISITION OF SPORTS-RELATED SERVICES.” The above-referenced patent application is hereby incorporated by reference in its entirety into the present application.

### BACKGROUND

### 1. Field

Embodiments of the current disclosure relate to providing networking connections for sports-related services. Specifically, embodiments of the current disclosure relate to facilitating sports-related connections between entities based on entity profiles using machine learning.

### 2. Related Art

Typically, trainers and athletes connect via word of mouth, online postings, advertisement, or through local brick and mortar training facilities. Parents take their children to the local sports training facility and meet with an instructor or trainer based on availability and classes. Many times, these classes are standardized for groups of athletes and set according to a specific schedule during the week. In many cases the student doesn't get to be in the class that may be best suited for the student. Likewise, the instructor, or trainer, may also be restricted to classes based on mass need rather than individual needs of the trainer and/or the athlete. Furthermore, the athletes and trainers are typically restricted by location.

Current methods of ranking, evaluating, and recruiting athletes include leveraging local scouts to watch athletes and provide feedback on their performance. In some cases, athletes come together in large groups for “combines” to demonstrate skills for attending recruiters or coaches. Typically, if the recruiting entity is interested in the athlete, the recruiting entity will then send a representative to watch the athlete or bring the athlete to their facility for a supervised workout. This is a long, drawn-out process that results in a large network of people to find, evaluate, and network with recruits. In some cases, recruits may be overlooked by local scouts with little experience.

What is needed is a networking application providing knowledge of the athletes and training programs for optimal matching of athletes, trainers, programs, education facilities, and the like.

### SUMMARY

Embodiments of the invention solve the above-described problems and provide a distinct advance in the art by providing a sports services system that determines likelihoods of achieving successful objectives between sports-related entities. Data associated with the sports-related entities may be analyzed by statistical and/or machine learning algorithms to match sports-related entities that provide a high likelihood for maximizing objectives of the sports related entities.

An embodiment comprises one or more non-transitory computer-readable media storing computer-executable instructions that, when executed by at least one processor, perform a method of optimally connecting a first entity with at least one second entity over a communication network for providing sports-related services. The method comprises obtaining entity data associated with the first entity, wherein the entity data comprises a plurality of input parameters indicative of a sports profile of the first entity, obtaining a sports-related objective of the first entity, obtaining global entity data from a plurality of sports-related entities, comparing, by a machine learning algorithm trained on a history of sports-related data, the plurality of input parameters with the global entity data from the plurality of sports-related entities, and determining a likelihood of success of the sports-related objective associated with the at least one second entity of the plurality of sports-related entities based on a set of associated input parameters of the at least one second entity.

An embodiment comprises one or more non-transitory computer-readable media storing computer-executable instructions that, when executed by at least one processor, perform a method of optimally connecting a first entity with at least one second entity over a communication network for providing sports-related services. The method comprises obtaining first entity data associated with the first entity, wherein the first entity data comprises a first plurality of input parameters indicative of a sports profile of the first entity, obtaining second entity data associated with a second entity, wherein the second entity data comprises a second plurality of input parameters indicative of a sports-related service, obtaining global entity data from a plurality of sports-related entities, comparing the first plurality of input parameters, the second plurality of input parameters, and the global entity data from the plurality of sports-related entities, matching the first entity with the second entity based on the comparing, wherein the first entity data comprises financial information of the first entity, and facilitating a transaction between the first entity and the second entity for the sports-related service.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the current invention will be apparent from the following detailed description of the embodiments and the accompanying drawing figures.

### BRIEF DESCRIPTION OF THE DRAWING FIGURES

Embodiments of the invention are described in detail below with reference to the attached drawing figures, wherein:

FIG. 1 depicts an exemplary hardware platform that for certain embodiments of the invention;

FIG. 2 depicts an embodiment of a sports services system comprising a communication network linking entities;

FIG. 3 depicts an embodiment of exemplary entities linked through statistical and machine learning algorithms;

FIG. 4 depicts an exemplary process of connecting entities through machine learning analysis of sports-related input parameters;

FIG. 5 depicts an exemplary diagram of a marketplace and transaction communication system of the sports services system; and

FIG. 6 depicts an exemplary dashboard providing an interface of the sports services system.

The drawing figures do not limit the invention to the specific embodiments disclosed and described herein. The drawings are not necessarily to scale, emphasis instead being placed upon clearly illustrating the principles of the invention.

### DETAILED DESCRIPTION

The following description of embodiments of the invention references the accompanying illustrations that illustrate specific embodiments in which the invention can be practiced. The embodiments are intended to describe aspects of the invention in sufficient detail to enable those skilled in the art to practice the invention. Other embodiments can be utilized, and changes can be made without departing from the scope of the invention. The following detailed description is, therefore, not to be taken in a limiting sense.

In this description, references to “one embodiment”, “an embodiment”, “embodiments”, “various embodiments”, “certain embodiments”, “some embodiments”, or “other embodiments” mean that the feature or features being referred to are included in at least one embodiment of the technology. Separate references to “one embodiment”, “an embodiment”, “embodiments”, “various embodiments”, “certain embodiments”, “some embodiments”, or “other embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the current technology can include a variety of combinations and/or integrations of the embodiments described herein.

Generally, embodiments of the current disclosure comprise facilitating optimized connections between entities based on learned histories of success of connections between sports-related entities. A sports services system may obtain sports-related data from various entities for matching the various entities across a network using statistical and machine learning algorithms to maximize an objective of the various entities. The user data associated with each entity may be compared to maximize the opportunities for each entity to provide best options for sports achievements, goal realization, and career development while maintaining social and emotional health for all entities.

Entities, as described herein, may be any computing device user, business entity, company, non-profit, person, group of people, and/or sporting team/group such as, a local club, an individual athlete, a trainer, a training club, a youth program, an elementary-/middle-/high-school, college/university and/or professional team associated with embodiments of the sports services system in the current disclosure. Any entity may connect with any other entity via the sports services system. Generally, as a matter of example, the description herein is between a trainer and an athlete. Though, it should be noted, that this is exemplary, and the trainer and athlete described herein may be any entity described above.

As a matter of example, a plurality of trainers may be looking to provide education classes to the plurality of athletes, and a plurality of athletes may be looking for training classes at various times and locations. In some embodiments, trainers of the plurality of trainers may also be athletes at higher levels than the athletes looking for education. For example, a trainer may be a college basketball player that may specialize in defense. The trainer may provide a defensive training class virtually, in-person, or in a hybrid-style setting (i.e., in-person and virtually). The defensive training class may be posted on a sports services website and advertised across social media sites or any other media outlet. The sports services system may provide the advertisement, sign up for the training class, facilitate communication between the trainer and the athletes, and provide the class virtually or in a hybrid style. In some embodiments, the sports services system may provide contracts and facilitate payment for the classes by the sports services system through integration with third-party applications provided on secure servers. Furthermore, the contracts and payment for the trainers may be provided in specialized documentation for payment through programs such as Name, Image, and Likeness (NIL) through the National Collegiate Athletic Association (NCAA), professional organizations such as, for example, United States based sports organizations such as the NFL, MLB, NBA, WNBA, MLB, NWSL, PGA, LPGA, or the like including subsidiaries. These exemplary U.S. sports organizations are not limitation and the sports services system described herein may extend to any other country or international group comprising sports organizations at any level.

In some embodiments, the sports services system may provide data acquisition and analytics for the various sports and/or may facilitate integration with existing analytics systems. For example, sensors may gather data indicative of a high-school golfer's swing. The data may be analyzed using machine learning algorithms to provide to any other entity ranking data, technique improvement data, NIL value data, and the like. In some embodiments, user provided information, classes, analytics, and any other obtained user data may be used to create a profile for any entity. The various entities described herein may be matched based on various statistical and/or machine learning algorithms according to the entity profiles and historical success of maximizing entity objectives.

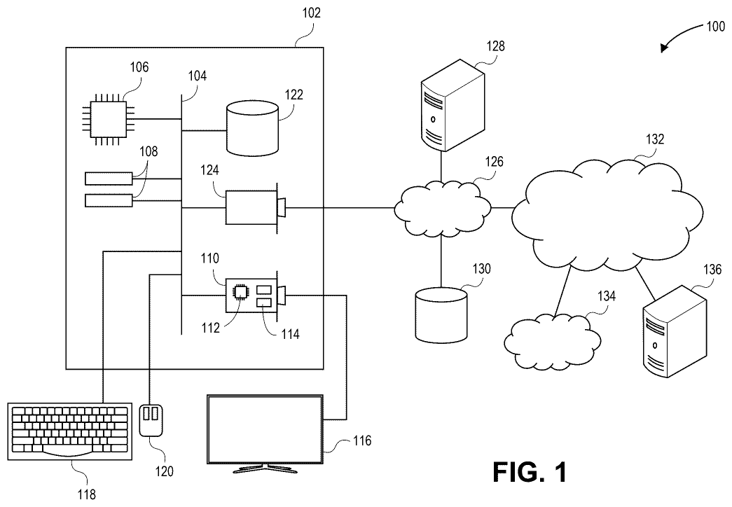

Turning first to FIG. 1, an exemplary hardware platform 100 that can form one element of certain embodiments of the invention is depicted. Computer 102 can be a desktop computer, a laptop computer, a server computer, a mobile device such as a smartphone or tablet, or any other form factor of general- or special-purpose computing device. Depicted with computer 102 are several components, for illustrative purposes. In some embodiments, certain components may be arranged differently or absent. Additional components may also be present. Included in computer 102 is system bus 104, whereby other components of computer 102 can communicate with each other. In certain embodiments, there may be multiple busses or components may communicate with each other directly. Connected to system bus 104 is central processing unit (CPU) 106. Also attached to system bus 104 are one or more random-access memory (RAM) modules 108. Also attached to system bus 104 is graphics card 110. In some embodiments, graphics card 110 may not be a physically separate card, but rather may be integrated into the motherboard or the CPU 106. In some embodiments, graphics card 110 has a separate graphics-processing unit (GPU) 112, which can be used for graphics processing or for general purpose computing (GPGPU). Also on graphics card 110 is GPU memory 114. Connected (directly or indirectly) to graphics card 110 is display 116 for user interaction. In some embodiments no display is present, while in others it is integrated into computer 102. Similarly, peripherals such as keyboard 118 and mouse 120 are connected to system bus 104. Like display 116, these peripherals may be integrated into computer 102 or absent. Also connected to system bus 104 is local storage 122, which may be any form of computer-readable media and may be internally installed in computer 102 or externally and removably attached.

Computer-readable media include both volatile and nonvolatile media, removable and nonremovable media, and contemplate media readable by a database. For example, computer-readable media include (but are not limited to) RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These technologies can store data temporarily or permanently. However, unless explicitly specified otherwise, the term “computer-readable media” should not be construed to include physical, but transitory, forms of signal transmission such as radio broadcasts, electrical signals through a wire, or light pulses through a fiber-optic cable. Examples of stored information include computer-useable instructions, data structures, program modules, and other data representations.

Finally, network interface card (NIC) 124 is also attached to system bus 104 and allows computer 102 to communicate over a network such as network 126. NIC 124 can be any form of network interface known in the art, such as Ethernet, ATM, fiber, BLUETOOTH, or Wi-Fi (i.e., the IEEE 802.11 family of standards). NIC 124 connects computer 102 to local network 126, which may also include one or more other computers, such as computer 128, and network storage, such as data store 130. Generally, a data store such as data store 130 may be any repository from which information can be stored and retrieved as needed. Examples of data stores include relational or object-oriented databases, spreadsheets, file systems, flat files, directory services such as LDAP and Active Directory, or email storage systems. A data store may be accessible via a complex API (such as, for example, Structured Query Language), a simple API providing only read, write and seek operations, or any level of complexity in between. Some data stores may additionally provide management functions for data sets stored therein such as backup or versioning. Data stores can be local to a single computer such as computer 128, accessible on a local network such as local network 126, or remotely accessible over Internet 132. Local network 126 is in turn connected to Internet 132, which connects many networks such as local network 126, remote network 134 or directly attached computers such as computer 136. In some embodiments, computer 102 can itself be directly connected to Internet 132.

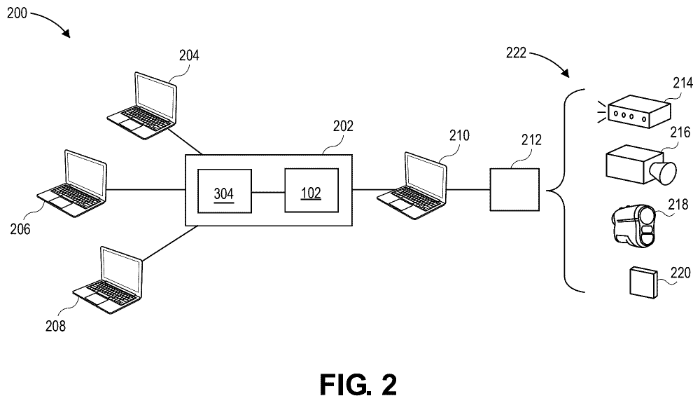

FIG. 2 illustrates sports services system 202 comprising a communication network facilitating communication between a network of device 200 serving various entities for acquiring sports-related services. In some embodiments, sports services system 202 may communicate with exemplary first entity computing device 204 and second entity computing device 206. Here, the various computing devices may be computer 102 as described above. Furthermore, sports services system 202 may be computer 102 and may provide various services to the various user computing devices. The computing devices may run a sports services application in communication with sports services system 202 and/or may provision a cloud-based service from sports services system 202. Sports services system 202 may cause display of a user interface by the various computing devices and generate the functionality for providing the sports-related services described herein.

In some embodiments, sports services system 202 may communicate with computing devices 204, 206, 208, and 210, data acquisition programs 212 and sensors 222, wherein computing device 210 may be third-party servers for data acquisition and analytics, and the like. In some embodiments, third-party entities may provide additional services such as, for example, sports psychiatry, career advancement and placement, and the like by third-party computing device 208.

Users of sports services system 202 may be, for example, trainers and athletes accessing sports services system 202 by first entity computing device 204 and second entity computing device 206. Trainers may provide various data to a trainer profile to acquire students/athletes for training classes. The trainers and the athletes may provide user data that may be used to generate user profiles, the user data including items such as relevant sports, classes for teaching or desired/objective learning, focus of class (e.g., offense, defense, shooting, dribbling, passing, throwing, accuracy, speed, strength, swing, and any combination thereof). Furthermore, trainers and athletes may provide information such as age, sex, gender, race, background, physical characteristics, mental acumen, certifications, education, experience, and the like, which may be input as stored as user data associated with the entity (e.g., athlete or trainer) profile. The user data may be accessible to trainers, recruiters, and the like. For example, the user data (including video) may be aggregated into virtual combines to allow recruiters to view a collection of eligible athletes or athletes playing a particular position.

In some embodiments, sports services system 202 may provide waivers to all or a portion of the user data. The user may customize the data that is available to outside parties by tiers. The user may create various tiers of user data. For example, tier 1 may include performance metrics, such as speed, jump, explosiveness measurements, etc. Tier 2 may include physical characteristics, such as height, weight, arm length, head size and the like. Tier 3 may include items, such as locations, college/professional interests, goals, and the like. Tier 4 may include personal information, such as sex, ethnicity, home address, and the like. The user may provide access to the various tiers of data by customizing each tier and providing the data to individual other user's or signing waivers releasing the data to others.

In some embodiments, the trainer may input additional user data indicative of the trainer's physical characteristics, schedule and location, experience and certifications, and the like. The user data may include any information associated with any entity that may be used to evaluate the entity as described in embodiments herein. The user data may provide key data points that may be input into entity models for determining a likelihood of success for the users of sports services system 202. A profile for each user, the trainer in this example, may be stored such that the data associated with the trainer may be compared to other users to determine the likelihood of success if the trainer trains the other users. The likelihood of success may be based on matching data as well as historical data associated with the users and the history of the trainer. Here, an objective may be maximizing performance of an athlete. As such, the analysis may include the trainer's history of success of improving performance athletes that have participated in the trainer's classes.

In some embodiments, as described above, the entity may be a user and the user may be an athlete looking for a trainer or a training program. The athlete may represent an athlete at any level or may be a representative of the athlete such as a parent or a sports agent. Furthermore, in some embodiments, the trainer may be an agent or trainer representative. The athlete may input user data such as age, sex, gender, sport, team affiliates, favorite players, similar players, hobbies, schedule, location, experience, and the like. Furthermore, user data may be obtained from the user from third-party applications and databases, the user data including performance statistics, performance achievements, athletic history, social history, and the like. In some embodiments, the user data may be used to generate a profile for the athlete. Each user datum may be a data point in statistical and machine learning algorithms trained to connect the athlete with the trainer or training program to maximize the objectives of the athlete/trainer. The entity matching phase is discussed in more detail below.

As described herein, the user profiles may include information indicative of the specific entity to which the user profile is assigned. The user profiles may include entity type such as, for example, athlete, trainer, business, university, community college, professional, armature, and the like. The user data may be used to represent the entity for display to other entities by displaying some information about the entity. For example, sports services system 202 may cause display of a user interface by the computing devices 204-210 as described above. Furthermore, each data point of the user data may be used as an input into the statistical and machine learning models for analysis of the user data of all entity profiles. As such, the user data for each entity may include all data associated with and indicative of the entity to which the data is associated/assigned. As such, any entity may be represented by any data that the entity provides or is obtained or determined by sports services system 202. In some embodiments, the entities may customize the information that is displayed to represent them to other entities.

Furthermore, as shown in FIG. 2, sports services system 202 may communicate with sensors 222 and provide data analysis and virtual and augmented reality, generally referenced herein as VR. Sports services system 202 may obtain data from sensors 222 such as, for example, optical sensors 214, cameras 216, radar 218, and other general sensors 220 such as, for example, accelerometers, rate gyros, strain gauges, and the like. Data may be obtained via sensors 222 to evaluate activity of an athlete such as, for example, running, swimming, swinging, lifting, throwing, blocking, dribbling, shooting, and the like. The obtained data may be analyzed based on machine learning models trained on a stored history of training data as described in embodiments below. The obtained user data may be stored with the user profile and used to market the athlete and/or connect the athlete with various entities as described in embodiments herein. In some embodiments, sports services system 202 application may integrate with third-party applications providing the data acquisition, VR, and/or analytics described herein. The athlete may perform exercises or sports-related movements while the sensors record the data, and the data may be stored in the user profile and analyzed for matching, ranking, marketing, and the like.

In some embodiments, sensors 222 may comprise a plurality of cameras 216 for obtaining user data and providing simulations and comparisons. The plurality of cameras 216 may provide monitoring and simulation for golf, baseball, basketball, football, soccer, and the like. The athlete's performance may be quantified by sports services system 202. For example, a golfer may use a golf monitor for swing data acquisition. Sports services system 202 may use the obtained user data to analyze the golfer and determine an overall comparison to averages of professional athletes on the PGA tour, model a value for NIL in college, determine universities that are in need of a golfer of the golfer's profile, and the like. Furthermore, the analysis my detect characteristics in the golfer's swing that lead to negative results such as inconsistencies and/or shorter distances. Sports services system 202 may connect the golfer to local and/or virtual trainers that provide a high likelihood of correcting these negatives in the golfer's swing. Therefore, sports services system 202 provides optimal detection and connections to services to assist any entity with objectives in sports-related activities using the algorithms described in detail below.

In some embodiments, the plurality of cameras 216 may comprise a set of cameras for 3-dimensional modeling of the movements of the athlete. The three-dimensional model may be used to profile the athlete's performance characteristics as feedback for improvement. The three-dimensional models may also be stored in the athlete's profile and accessible by recruiters, draft analysts, and professional scouts and administrators.

In some embodiments, third-party computing device 208 may be associated with a third-party service for the entities. The third-party services may be, for example, psychiatrists, sports psychiatrists, medical establishments, financial professionals, agents, and the like. The third-party data may be input into analysis engine 304. In some embodiments, the third-party services may have access to the user data, user profile, and the results of any analysis performed by sports services system 202.

In some embodiments, sports services system 202 facilitates connections to the third-parties and provides recommendations based on the results of the analysis. In some embodiments, part of any objective may be to determine quality-of-life and well-being for any entity. If the quality-of-life and well-being scores are low, third-party psychiatrists may be provided. For example, an athlete may move from a rural location where they have lived their entire life to an urban environment for higher education on an athletic scholarship. Similarly, an athlete may move internationally. This may be a drastic change in the athlete's life. Analysis engine 304 may determine that there is a high likelihood that the athlete may suffer from mental illness or setbacks based on their social activities and has a high likelihood of moving back home after the first year. Therefore, third-party entities may be presented to the athlete such as, for example, psychiatrist, familiar clubs, social groups with similar hobbies and interests, cultural clubs, and the like. In some embodiments, international players may be put in contact with people from their home country. Furthermore, in some embodiments, local sports psychiatrists, medical professionals, financial professionals and the like, may be presented to the athlete based on the user data analysis and matching phase.

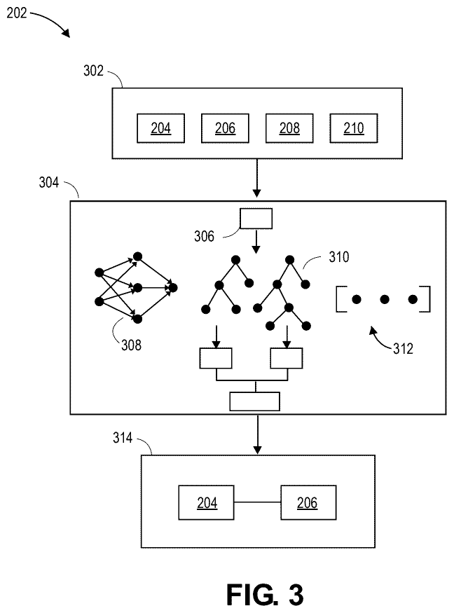

FIG. 3 depicts an exemplary flow of data collected by sports services system 202 and fed into exemplary algorithms for analyzing the user data for evaluating the various entities for ranking and matching the entities. At block 302, data may be obtained by computing devices 204-210. The data may be indicative of entities from first entity computing device 206 and second entity computing device 206. Third-party computing device 208 may provide physical characteristics, psychologic data, experience, certifications, medical information, and the like from third-party entities. Computing device 210 may provide sports data and analytics from sensors or third-party data acquisition and analytics applications and/or databases. Furthermore, if the entity here is an educational institution, professional club, or the like, the data may be indicative of the team, players on the team, team needs, current player profiles, team needs, desired player profiles, financial budget, school size, associated conference, coaches, administrators, school population demographics, sports demographics, and the like.

Once the entire set, or global set, of user data is obtained, the user data may be organized and fed into analysis engine 304. At analysis engine 304, the user data may be precondition and classified for further analysis at block 306. Simple analysis may be performed such as general classifications. For example, entities may be classified by sport (e.g., soccer, baseball, basketball, etc.), sex, gender, location, or the like. Similarly, or alternatively, a more in-depth analysis may be performed for classifying and optimizing user data to store in the user profile such that the user data may be analyzed or pre-conditioned, for classification and matching.

In some embodiments, preconditioning may serve to standardize the data for analysis by neural network 308, decision trees and/or random forest 310, or other statistical and machine learning algorithms 312, and/or the user data may be feature engineered for more efficient analysis and quicker convergence of optimized results. The user data may be filtered using feature engineering models to maximize the rewards, representative of the objectives, for providing the best data to the predictive algorithms. When data sets are found to have little or no effect on the outcome, these data sets may be eliminated from the user set for analysis in the predictive models. For example, the user data may be analyzed to find that the entity is a golfer looking for a division one collegiate program. In some embodiments, the user data may be analyzed, and it may be determined that the entity is a golfer and based on their statistics, experience, and the like, they should be looking for a division one collegiate program, or the golfer's determined ranking is college division-one level, so unnecessary data (here, non-division one programs) is filtered out prior to the matching phase. As such, a preliminary filter may be provided to efficiently process the user data in the predictive phases.

In some embodiments, the input states to the feature engineering model may be processed to determine features for input into the predictive models. Generating these features may reduce the total variables processed by the predictive model saving time and processing power during the inference phase of the predictive models. When the training phase is complete, the final model comprising the final features may be put into use processing new data as input by entities utilizing sports services system 202. In this way only variables that are useful to the given conditions may be used. This may be based on detecting specific data points such as “golf,” “male,” “swing speed,” etc., and the like from the user profile of the golfer described above. Any of the algorithms described below may be used to classify and filter the user data for further analysis in the user data preconditioning phase.

After the user data has been filtered for more efficient and affective analysis, the data may be fed into the predictive models, or “matching” phase. The matching phase may comprise one or more machine learning algorithms trained for matching entities to maximize a likelihood of success. “Success” here, may be any desired outcome, or objective, and may be represented as a likelihood compared to a threshold value. In some embodiments, success may be a high likelihood of athletic improvement, monetary compensation, contract signing, class attendance, achievement of defined goals, certification acquisition, prospect ranking improvement, team/club membership, recruiting, being recruited, and the like.

In some embodiments, the analysis may be performed by neural network 308, decision trees and/or random forest 310, or other statistical and machine learning algorithms 312 including clustering, optimal and greedy matching, regression analysis, and the like for determining the best fit for the first entity with the second entity based on the analysis of the user data of the first entity with global data of all entities initially classified to be potential matches. The algorithms may compare the user data with the global entity data to determine the highest likelihood of successfully maximizing or achieving the objective set forth by the first entity or an objective determined or defined by analysis engine 304.

In some embodiments, the objectives described above may be analyzed, but further objectives may be analyzed automatically to capture potential unknowns. For example, potential unknowns may be quality-of-life, physical and mental well-being, coach/athlete relationship, and the like. As such, social changes may be modeled. These extraneous objectives may provide warnings for an entity that social changes may negatively or positively impact the decisions to select education institutions, cities, countries, teams, coaches, trainers, and the like. Furthermore, trainers, coaches, teams, and the like may receive warnings of particular prospects based on a prospect's past. Modeling these social behaviors may impact the likelihood of success of connections between any entities and may be modeled alongside any athletic relationships described herein.

In some embodiments, the financial information may be utilized as inputs into the machine learning models and the feature selection processes. As described above, the global sports-related data includes statistical data, financial data, and the like. Furthermore, entity data may be used in the machine learning model as described above. The entity data may comprise financial data (e.g., account data, credit history, and the like) associated with each entity and the global data may comprise historical financial data (e.g., other users' financial history, third-party data and statistics, and the like). The entity data and the global data may be reduced to only input variables that have a significant impact on the objective function of the machine learning model, as described in the feature selection analysis above. In this way, the data is reduced during the training phase to limit unnecessarily processing insignificant inputs in the prediction phase. Furthermore, in some embodiments, the inputs may also include results from previous prediction analysis. As such, the results of each training phase may increase the confidence in the input parameters selected for analysis. This feature engineering model may be used to determine inputs for objectives in the machine learning models such as, for example, determining credit levels and pre-banking quantity and approval, determining loan quantity and approval, and the like. The feature engineering model may be used for any financial and matching analysis described herein. Furthermore, any of the above-described machine learning models may be utilized for optimizing the objectives.

In some embodiments, an entity such as a recruit or an athlete, referenced as the athlete, may sign up to sports services system 202 and provide user data that can be used to generate the user profile described above. The data points of the user profile may then be analyzed for association with stored data points of other entities to generate a list of associated entities with a high likelihood of success. For example, a high-school basketball athlete may struggle with shooting free throws. The athlete, or representative, may open a profile on sports services system 202 to find a class teaching free throw shooting. The athlete may simply enter their profile including shooting percentages and the like, and analysis engine 304 may determine a likelihood of improving free throw percentage, location, scheduling, and compare any other relevant data points through the machine learning algorithms of the analysis engine 304. The one or more classes, camps, trainers, and the like with the highest likelihoods of successfully improving free throw percentage based on the attributes of both entities may be presented to the athlete. As such, the optimal solutions for the athlete are determined and provided to the athlete. These associations may connect athletes with trainers to provide the highest likelihood of strengthening that athlete's education and training.

In some embodiments, training facilities may be analyzed along with the coaches and trainers. Activities, classes, business hours, facility traffic, and the like may be evaluated for matching the best available facilities and trainers to the athlete. For example, the user may be an athlete that is looking for a trainer in a particular radius because the user only utilizes public transportation and is only available outside of school and a part-time job. These location and timing parameters may be input into sports services system 202 and evaluated for the best fit for the athlete. For the facility, the parameters such as, for example, court types, number of courts, class schedule, busy times, and the like may be evaluated from historic trends, bookings and booking trends, related searches and the like. As such, sports services system 202 may provide the facility and trainers with the highest match for the athlete's required location and availability as well as training needs.

The process for determining the best class/trainer/location to improve the athlete's training and education described above may be applied to an entity recruiting an athlete or attempting to find students for a class. For example, the entity may be a scout or recruiter. Continuing with the golf example above, the golfer may upload their user data creating a user profile by sports services system 202. Similarly, University A may be looking for a specific type of golfer. The golf team at University A may have many golfers that are accurate but struggle on long courses because University A's golf team lacks distance compared to the average. Analysis engine 304 may obtain user data associated with University A and the golfer and determine a high likelihood of the golfer signing with University A and University A's golf team improving by a calculated amount based on the additional statistics associated with the golfer's profile. Therefore, the golfer and University A may have a high likelihood of success and may both benefit from the match. As such, sports services system 202 connects the golfer with University A.

In some embodiments, prospects and trainers may be evaluated for performance and experience for certification. The user data may be analyzed by analyzing engine 304 to determine an athletic performance level associated with known thresholds for achievement. The known thresholds for achievement may be indicative of levels of certification of performance and training. The analysis may quantify experience, athletic achievements, student successes, recorded motions, statistics, and the like. For example, a trainer may be awarded a certification based on a tracked objective success of students of the trainer. In another example, a martial arts athlete may record themselves performing combat moves, or a history of competitions and results may be stored and analyzed. The recording may be analyzed by the machine learning algorithms and a level of achievement indicative of a belt color designation may be applied. The martial artist may then be digitally awarded the belt and a notification may be sent to a trainer of the martial artist that the martial artist has achieved this milestone. Similarly, a golfer may record course scores and analysis engine 304 may track handicap based on the golfer's scores and course statistics. The handicap may be updated regularly based on the previous 20 courses played and the results. The certifications may be evaluated by regulatory agencies and/or representatives for accuracy and/or may be accepted based on successful output and reputation of accuracy.

In some embodiments, sports services system 202 may provide time and location searching, scheduling, and certification for workouts, physicals, drug testing, and the like. Many sports organizations require physicals and drug testing as well as some certifications to start a season. Teams may provide requirements and instructions by sports services system 202 to users to obtain these requirements before beginning practice or before the first match. Sports services system 202 may provide links, locations, and scheduling for the users to fulfill these requirements before the deadlines. Furthermore, sports services system 202 may provide transportation requests along with the schedules such that users may have access to the necessary facilities. As described herein, sports services system 202 may interface with third-party apps for scheduling the physicals, drug tests, and the like.

In some embodiments, prospects may be ranked for various levels of athletics such as high school, college, and professional. The inputs to the above-described algorithms may be indicative of the prospect's performance (or talent measurements) as well as physical characteristics (e.g., height, weight, speed, quickness, explosiveness, hand size, foot size, head size, frame, etc.). The user data may be analyzed by analysis engine 304 to classify athletes and rank the athletes according to the classifications. For example, the athletes may be classified in a first category of football players, in a second category by offense or defense, in a third category by position (e.g., defensive line including sub-categories of edge, defensive end, interior; defensive back including sub-categories of safety, corner, nickel; linebacker, etc.). These rankings may be based at least in part on the above-described performance metrics or talent of the prospects. The user data associated with each athlete of the plurality of athletes may be analyzed by analysis engine 304 to rank likelihood of success at the respective levels of competition based on historical training data. For example, the machine learning algorithms may be trained on the success and user data of historic athletes providing algorithms for determining a likelihood of success for each prospect of the plurality of prospects at each level of athletics and each category of sport and position. The analysis results may be provided to sports institutions of the various levels of competition such that the sports institutions may better evaluate the prospects. Sports services system 202 may then connect the entities with the highest likelihood of success at block 314.

Furthermore, the above-described prospect rankings and likelihood of success for players may be made available to both national and international teams. As such, teams may be looking for players of a particular metric similarly to the golf example above. For example, a football club in England may be looking for a striker with certain performance metrics. The football club may input the desired parameters defining their “ideal” striker. The highest match may be Brazilian footballer under contract with a different club. Sports services system 202 may determine market value for the Brazilian footballer comprising contract details as well as trade value. In some embodiments, sports services system 202 may locate value (players/compensation) on the current roster of the English football club and request permission to make an offer. Once permission is obtained, sports services system 202 may make the offer to the Brazilian football club that currently holds a contract for the Brazilian footballer. Furthermore, the Brazilian football club may accept the offer, and sports services system 202 may conduct the trade by providing the required contracts and trade details.

In some embodiments, sports services system 202 may analyze the user data to predict NIL contracts and determine NIL value of athletes and NIL funds of potential colleges and universities. A financial potential of each athlete and educational program may be determined by the machine learning algorithms trained on the historical data. The prospect's athletic success and popularity may be modeled based on the user profiles weighted against the historic data. In some embodiments, the potential may be evaluated based on historical trends and linear, polynomial, and logarithmic functions may be utilized to predict future NIL value and possible contracts. As such, the NIL value of prospects may be determined and ranked. The prospects may be matched with colleges and universities based on maximizing NIL value, maximizing athletic potential, maximizing living conditions, maximizing a set of desires (i.e., objectives) associated with the prospect, or any weighted combination thereof. Future trends described here may be applied to any of the above-described analysis.

In some embodiments, the athlete may be represented by their parents and the training may be kids clubs, youth leagues, elementary/junior/senior high school, or the like. Sports services system 202 may provide a social community for the athlete's representatives. Sports services system 202 may provide communication including calendars and schedules and the like for parents to fill in as coach when other parents are on vacation or out. The parents may schedule ride shares or commuting options and reschedule practices and games when many athletes and/or parents are not available. The community aspect may further provide lists of users and schedules such that youth teams and organizations may be formed and run on sports services system 202.

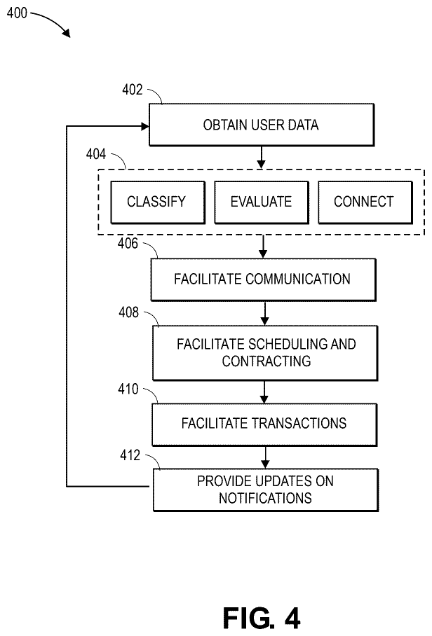

FIG. 4 depicts an exemplary process 400 for linking entities across a network based on the user data analysis by sports services system 202. At step 402, sports services system 202 may obtain user data indicative of entities and the entities sport-related data. The user data may include user input data such as, for example, age, sex, gender, sport, team affiliates, favorite players, similar players, hobbies, schedule, location, experience, and the like. Furthermore, the user data may include obtained data such as, for example, sports performance statistics, athletic statistics, measurable data (e.g., physical characteristics, strength output, speed, endurance, etc.), video performance data, images, and the like. In some embodiments, entities may be athletic institutions (e.g., high-school programs, college and university athletic programs/teams, professional organizations, etc.). The user data associated with the athletic institutions may include offered sports categories and sub-categories, financial information (e.g., past, current, and future budget, etc.), team needs (e.g., position, player profile, statistics, etc.), and the like.

Furthermore, sports services system 202 may obtain and/or assign objectives to each entity of the plurality of entities. The objectives may define an optimization objective for the entities. For example, objectives may be performance improvement, career development, goal achievement, financial improvement, awards and certification acquisition, lifestyle, wellness, and the like.

At step 404, the user data is input into analysis engine 304 where all global entity data may be classified, organized, and analyzed to match entities based on the user data while finding the highest likelihood of obtaining a successful objective. In some embodiments, analysis engine may provide various machine learning algorithms for achieving the successful matches including neural network 308, random forest 310, and other algorithms 312 including matching algorithms maximizing the objective functions. Generally, step 404 comprises the above-described analysis, certifications, valuations, and the like for matching entities in a sports-related field. It should also be noted that a plurality of weighted objectives may be analyzed simultaneously as described above.

At step 406, once a set of high likelihood matches a determined, communication between the matched entities may be facilitated. A first entity may be provided a list of potential second entities for joining. The first entity may contact a second entity by a link to any communication service associated with the second entity such as, direct messaging, email, social media, or the like. This provides a networking link between the entities. In some embodiments, the communication may be provided directly through a user interface of sports services system 202 integrated with a third-party application.

At step 408, sports services system 202 may provide scheduling and contacting options. The scheduling and contracting options may be in the form of scholarships, membership offers, player commitments, class schedules, training sessions, professional contracts, trades, NIL commitments, and the like. Any scheduling and contracting signatures may be complete directly through sports services system 202 and/or through third-party secure servers and services.

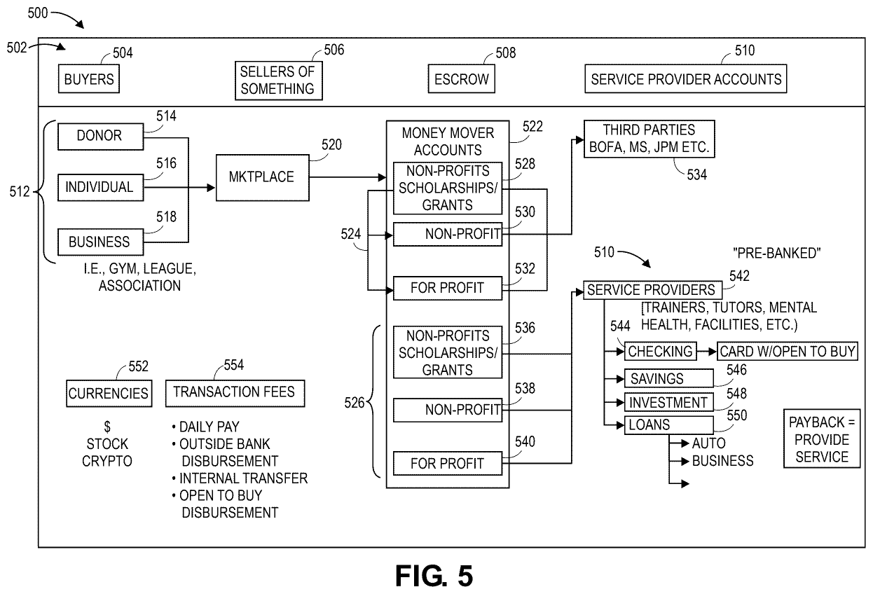

At step 410, transactions for the above-described services and contracts may be established through sports services system 202 and/or third-party secure servers providing financial accounts. Sports services system 202 may either provide the transactions directly between accounts by integrating with applications of the financial accounts and/or may integrate with third-party transaction facilitation applications for providing the financial transactions. An exemplary diagram of a market analysis and transaction system is shown in FIG. 5 and described in detail below.

At step 412, sports services system 202 may provide further communication and updating of any contracts, financial data, and the like. Furthermore, the processes described herein may be iterative and continuous and/or ongoing such that the objectives of the entities are tracked over time. Any performance improvements, certification acquisitions, awards, achievements, met goals, and the like may be automatically realized by analysis engine 304 and notifications may be provided to the corresponding entities.

All data may be tracked over time and fed back into analysis engine 304 for improving the machine learning models. As such, all models may be up to date for placement of entities in the sports world at any level.

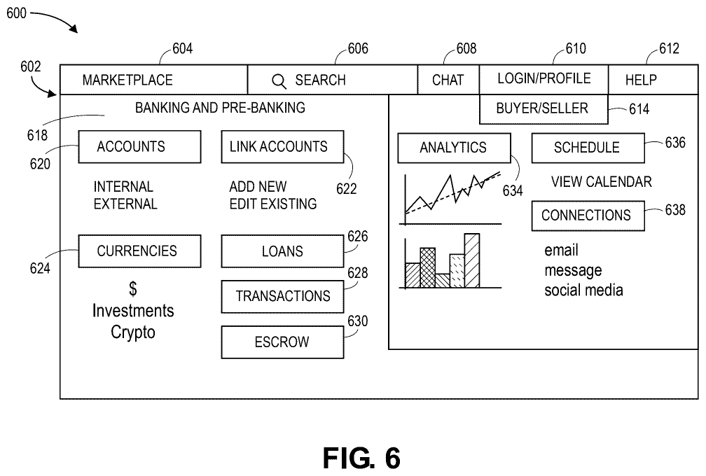

FIG. 5 depicts a diagram 500 of an exemplary marketplace and transaction communication system 502 of the sports services system 202, the marketplace and transaction communication system 502 providing transactions between links, transactions, and communications described herein. The marketplace and transaction communication system 502 may provide transactions between any entity described above for any service provided in embodiments described herein. An exemplary dashboard 600 (FIG. 6) linking the various entities (e.g., donor 514, individual 516, business 518, etc.) by marketplace 520 and various accounts and third-party providers. Exemplary entities 512 may be any of those described above for matching athletes, coaches, parents, families, organizations, and the like.

In some embodiments, sports services system 202 comprises marketplace and transaction communication system 502 providing internal accounts 524 as well as communication connections between various entities such as, for example, buyers 504, sellers 506, escrow accounts 508, and service provider accounts 510. In some embodiments, profiles and accounts may be provided and stored directly by sports services system 202 or may be external third-party accounts that are linked through communication networks and provide access to the user by dashboard 600.

In some embodiments, exemplary entities 512 interact with marketplace 520 to conduct transactions with various accounts (e.g., money mover accounts 522) provided by, and/or facilitated by, marketplace and transaction communication system 502 of sports services system 202. Money mover accounts 522 may include various entity accounts provided by and/or accessible by entities via marketplace and transaction communication system 502. Money mover accounts 522 may include connections to external accounts 524 such as, for example, organization non-profit accounts 528, private non-profit accounts 530, and for-profit accounts 532. The various accounts described herein are exemplary and any accounts associated with any internal entity or external third-party entity may be included.

In some embodiments, external accounts 524 may include third-party providers 534, for example, banks and/or online transaction media and/or account holders (e.g., PAYPAL, VENMO, and the like). The various banks may be any financial institution capable of online access and transactions and may include types of standard business account (e.g., non-profit and for-profit checking, savings, debit, and the like). Furthermore, externally linked accounts through third-party providers 534 may provide loan, escrow, investment accounts, and the like. Further still, externally linked accounts (i.e., external accounts 524) may include various third-party transaction service social media accounts (e.g., PAYPAL, VENMO, CASH APP, and the like). Marketplace and transaction communication system 502 may provide access to any user to conduct external-to-external, internal-to-external, external-to-internal, and internal-to-external transactions and communication utilizing dashboard 600.

In some embodiments, money mover accounts 522 include internal accounts 526. Internal accounts 526 may further comprise internal non-profit accounts 536, internal non-profit accounts 538, and internal for-profit accounts 540. Internal accounts 526 may be provided to any of the above-described entities and may be used to facilitate transactions between the entities directly through marketplace and transaction interface 602 utilizing dashboard 600. For example, service provider entities, or sellers 506, (e.g., tutors, trainers, mental health providers, facility providers, and the like) may hold accounts on marketplace and transaction communication system 502. The accounts may be linked with other entities and/or external accounts 524 and transactions between accounts may be performed with or without third-party involvement. This provides direct, automatic, and real-time transactions for checking, savings, investments, loans, escrow accounts, insurance, and the like.

In some embodiments, internal accounts 526 may include accounts of various service providers, or sellers 506. For example, the service provider accounts 510 may include checking, savings, investments, loans, insurance, and the like, and may provide an all-in-one stop for accessing and managing these various accounts for the user's business including service and communication with the buyer entities. Transaction system 502 may include business planning and business management models for sellers 506. Scheduling models and open-to-buy models may be accessible by a selling user and may provide all-in-one business profiles. For example, a trainer may set up a training facility where athletes may attend training sessions. Through external accounts 524 and/or internal accounts 526, the trainer may link external and internal accounts such that an entire business solution may be provided by transaction system 502. The entire business solution may provide scheduling, planning, financing, analysis, as well as customer acquisition and retention tools, and the like.

As described above, sports services system 202 provides optimal links between entities in need of sports related services and entities providing sports related services. Marketplace and transaction communication system 502 provides all business-related features linking the first entity with the second entity. For example, a trainer may schedule sessions with athletes at a training facility. The trainer may train children, teenagers, and/or adults who may be amateur or professional. The trainer may train at a rented or owned facility or at a gym owned by a trainer employer or third party. Furthermore, the trainer may be associated with a professional- or school-associated sports organization and the facility may be owned by the organization or state, federally owned, or the like. The sessions may be provided in the facility or cast online by a streaming service. In some embodiments, marketplace and transaction interface 602 may link accounts of the athletes and trainers such that monthly, yearly, admission fees are either manually or automatically transferred for payment of the training fees. The transfers may be approved and scheduled such that the transfers occur periodically automatically.

In some embodiments, facility ownership may be managed using marketplace and transaction communication system 502. The trainer may lease the facility or own the facility through a bank loan and the bank may be an entity or a third party associated with the marketplace and transaction communication system 502. The payments may be automatically or manually made through transaction system 502. Furthermore, any insurance, escrow, and property tax may be managed and linked with the associated financial entities and/or third-party providers such that payments are made through transaction system 502. In some embodiments, any payroll and insurance for employees may also be linked and managed through the transaction system 502.

In some embodiments, transaction system 502 may provide automatic distribution of profits. For example, at the end of a designated period (e.g., week, month, quarter, year, etc.), profits may be distributed automatically to various service provider accounts 510 of service providers 542. For example, currency may be distributed to checking 544, savings 546, investments 548 (e.g., retirement, stocks, bonds, crypto, EFT, profit sharing, and the like) and any other accounts. In some embodiments, the distribution of funds may also be secured in savings accounts and distributed for various loans 550, debt payments, taxes, payroll, and the like.

In some embodiments, the distribution may be based on the business management models to provide automatic business expense disbursements. The distribution of income prior to calculation of profit may be disbursed to cover expenses based on historical spending and income to cover future costs based on future trends as calculated by the machine learning algorithms described above. For example, future trends may be calculated based on season (time), class enrollment, historical data, and the like. These past trends may be used to estimate future costs including overhead and determine cost distribution across any accounts including, checking, savings, tax withholdings, insurance, facility management, customer acquisition, and the like. Furthermore, each time these calculations are processed, losses and increases in efficiency for the business model may be calculated and the business model may be adjusted and/or recommendations to the business model may be provided.

As described above, transactions may include any type of item that holds value. As shown in currencies 552, currencies 552 may include fiat currency, property, stocks, bonds, nonfungible tokens (NFT), cryptocurrency, or any object that may hold value and may be traded. In some embodiments, currency may be transferred between international accounts and any exchange rates may be applied to the transactions initially by internal accounts that may be verified and applied by third-party international accounts. Furthermore, transaction fees 554 may apply to any transaction and may be withheld by sports services system 202. Transaction fees 554 may be applied to any transaction and the fees may include daily pay, external bank disbursements, internal transfer fees, open to buy transfers, and the like.

In another exemplary scenario, an athlete may set up a profile utilizing dashboard 600 (FIG. 6). The profile, as described above, may include opening of a checking and/or savings account for the athlete in an internal account 526. In some embodiments, the user, in this example the athlete, may connect an outside account from a third-party financial institution such as a bank or a credit union. The user may transfer funds between the external account and the internal account such that the user has funds that may be transferred between the user account and a college including, for example, athletic programs, endowment programs, financial aid, and the like. Therefore, all financial services for the athlete (e.g., financial aid loans, grants, scholarships, tuition, and the like) may be provided directly to the athlete and/or a family member or guardian of the athlete (i.e., an account associated with, in this case, the student athlete). Furthermore, the funds may be provided in a pre-banking scenario with backing by a third-party and/or based on a credit history of the user.

In some embodiments, accounts may be set up for the users for pre-banking such that transactions may be automatically verified before the transaction occurs. For example, the user may have a history of good payment and/or may have a high credit score. As such, the user may be preapproved for transactions. The services may be provided to automatically allocate transfers, credit, and cash withdrawals based on the various payments and transfer history.

In some embodiments, the entity/user may be a public, private, or government organization funding entities through scholarships, grants, name image and likeness and the like. Furthermore, the entity/user may be private companies that provide services such as, for example, training, training facilities, and any other services described herein. Further still, entities/users may be college and professional sports organizations.

To further encourage independent business operations for each entity, internal and external links to accounts such as, for example, checking, savings, investment, loans, and the like may be accessible all in one place as illustrated in the exemplary dashboard 600 of FIG. 6. FIG. 6 illustrates an exemplary dashboard 600 providing the above-described marketplace matching and transaction facilitation methods. In some embodiments, dashboard 600 may be provided to an entity such as, for example, an individual or an organization as described above. Dashboard 600 may provide an all-in-one location for managing business needs of the above-described entities by providing an interface between the entity, other entities, and sports services system 202.

In some embodiments, dashboard 600 provides marketplace and transaction interface 602. Marketplace and transaction interface 602 may provide access to the accounts and provide all services described above to all entities described above. Marketplace and transaction interface 602 is exemplary for illustrating interactions between entities and sports services system 202.

In some embodiment, marketplace and transaction interface 602 may provide various features such as, for example, marketplace 604, search features 606, chat features 608, login/profile features 610, and help features 612. In some embodiments, selection of these various feature may open new windows, new tabs, drop down menus, screens, and the like. Marketplace 604, for example, may provide access to other entity services and offers. For example, a seller, or user entity providing a service, may be logged in and select marketplace 604 and seller from buyer/seller selection 614. The seller may be provided entities looking for services associated with the seller service. In some embodiments, the seller profile is analyzed and the user's that are provided by marketplace 604 are based on commonalities between the seller profile and the buyer profiles. For example, if the seller is a youth sports league looking for new recruits for their sporting teams, marketplace 604 may provide a list of athletes meeting requirements such as location, age, gender, and the like. In another example, the seller may be a professional sports organization and the sellers may be college athletes and their associated rankings from third-party scouting systems.

Similarly, or alternatively, the buyer may select marketplace 604 and may be connected to sellers. The buyer may be the athlete describe above or any other above-described entity searching for service. The buyer may be provided sellers based on the buyer's profile. For example, the buyer may be a golfer looking for a local teacher or coach. Sports services system 202, by marketplace 604, may connect the buyer to local and/or online teachers and coaches. The connections described in embodiments herein may be provided through marketplace 604.

In some embodiments, marketplace and transaction interface 602 may provide standard tools such as search features 606, chat features 608, and help features 612. Search features 606 may provide search queries across any databases associated with any features provided by sports services system 202, including dashboard 600 features and third-party databases. Chat features 608 may connect to an online carrier and/or a third parties to provide communication features between any user associated with sports services system 202. The users referenced herein may have a profile or may be signed in as a guest to explore the various services provided by sports services system 202. Help features 612 may provide help options. Selection of help features 612 may provide answers to frequently asked questions as well as provide links to helpful information and connections to administrators associated with sports services system 202.

In some embodiments, marketplace and transaction interface 602 may provide banking and pre-banking services 618. Users may access accounts associated with or connected to third-party financial institutions. Banking and pre-banking services 618 may provide account interfaces 620 including access to internal accounts 524 and links to external accounts 526 (e.g., hyperlinks or communication links through internal accounts). For example, buying and selling entities may access internal accounts 524 and transfer funds between other entities and see and manage any funds that are banked with a third party or pre-banked such that the funds are provided with backing from the third party. Therefore, any user may be approved to transfer funds to pay for services and manage any accounts (internal or external) using sports services system 202.

Users may be provided access to all accounts and account management through link accounts 622 to manage existing internal and external accounts. Here, links may be added to specific third-party accounts and fund transfers may be managed. For example, the buyer may schedule transfers to and from the user account to pay for services from sellers. The user account may be the internal account that is associated with an external account. The user may schedule payments to other entities offering services and schedule transfers between external and internal accounts.

In some embodiments, various currencies may be transferred between the accounts. Currency interface 624 may be used to transfer currencies 552 between international accounts and exchange rates may be applied. Furthermore, alternative forms of currency may be transferred. For example, investments may be transferred, bought, traded, and sold and the like. Furthermore, cryptocurrencies and NFT may be transferred, bought, traded, and sold. All transactions may be managed through banking and pre-banking services 618.

Furthermore, loans interface 626 may be used to manage through banking and pre-banking services 618. Transactions interface 628 and escrow accounts 630 may further be managed under banking and pre-banking services 618. Users may apply for, provide, and accept loans by banking and pre-banking services 618. Furthermore, escrow accounts 630 may be managed. Escrow accounts 630 may provide access to internal accounts holding escrow funds. These escrow funds may be used for the loans and, similarly, may be held for any arrangements between entities to ensure that all legal obligations are met by both parties.

In some embodiments, analytics 634 may be provided by marketplace and transaction interface 602. Analytics 634 may comprise compiling, storing, and calculating data to determine relationships and results to provide to the entities and to determine content to provide the entities in the marketplace. Furthermore, recommendations may be provided to entities based on the analytics. The analytics may provide any results determined by the machine learning algorithms describe above. Furthermore, general trends and common statistical analysis of the business model may be provided to the entities.

In some embodiments, sports services system 202 may provide scheduling features 636, which may comprise an internal calendar and/or may be linked to a third-party calendar. The scheduling features 636 may provide links to chats, telephone calls, video calls, and the like. Furthermore, scheduling features 636 may provide calendar notifications as well as visual, audible, and tactile notifications when events are scheduled. For example, the athlete described above may have a training session at 1:00 PM that was scheduled manually be the athlete, by the trainer entity, or automatically based on schedule availability and analysis. The training session may be stored as an event in the calendar and may notify the user prior to the scheduled event.

In some embodiments, entities may connect using various connection features 638. Connection features 638 may provide email, chat, text, digital message, social media links, video chats, and the like. The connection features 638, as described above, may be internal, external, or may be links to third-party provided communications.

In some aspects, the techniques described herein relate to one or more non-transitory computer-readable media storing computer-executable instructions that, when executed by at least one processor, perform a method of optimally connecting a first entity with at least one second entity over a communication network for providing sports-related services. The method includes obtaining entity data associated with the first entity, wherein the entity data includes a plurality of input parameters indicative of a sports profile of the first entity, obtaining a sports-related objective of the first entity; obtaining global entity data from a plurality of sports-related entities; comparing, by a machine learning algorithm trained on a history of sports-related data, the plurality of input parameters with the global entity data from the plurality of sports-related entities, and determining a likelihood of success of the sports-related objective associated with the at least one second entity of the plurality of sports-related entities based on a set of associated input parameters of the at least one second entity.

In some aspects, the techniques described herein relate to a media, wherein the first entity is an athlete and the at least one second entity is one of a college, university, and a professional sports team.

In some aspects, the techniques described herein relate to a media, wherein the sports-related objective includes: the athlete joining the at least one second entity; and a performance improvement prediction for the athlete.

In some aspects, the techniques described herein relate to a media, wherein the sports-related objective further includes: a quality-of-life prediction for the athlete; and a Name, Image, and Likeness (NIL) valuation for the athlete.

In some aspects, the techniques described herein relate to a media, wherein the sports-related objective is a first sports-related objective; and wherein the method further includes: obtaining a second sports-related objective of the at least one second entity, wherein the second sports-related objective is acquiring the athlete, and wherein at least one second entity data includes a first set of characteristics similar to a second set of characteristics of the plurality of input parameters of the first entity.

In some aspects, the techniques described herein relate to a media, wherein the machine learning algorithm includes one of a neural network, a random forest, and an optimal or greedy matching algorithm.

In some aspects, the techniques described herein relate to a media, wherein the method further includes: obtaining third-party analytics data of the first entity from a third party; generating an athletic profile of the first entity based on the third-party analytics data, and connecting the first entity to a plurality of teams of the at least one second entity looking for prospects with a similar profile to the athletic profile of the first entity.

In some aspects, the techniques described herein relate to a media, wherein the at least one second entity is a trainer providing a set of training classes; and wherein the method further includes generating a training class schedule, providing advertisements for the set of training classes by third-party social media sites; providing registration for the set of training classes, receiving registration from the first entity for a training class of the set of training classes, and facilitating payment from the first entity to the trainer for the training class.

In some aspects, the techniques described herein relate to a method of optimally connecting a first entity with at least one second entity over a communication network for providing sports-related services. The method includes obtaining entity data associated with the first entity, wherein the entity data includes a plurality of input parameters indicative of a sports profile of the first entity; obtaining a sports-related objective of the first entity, obtaining global entity data from a plurality of sports-related entities; comparing, by a machine learning algorithm trained on a history of sports-related data, the plurality of input parameters with the global entity data from the plurality of sports-related entities, determining a likelihood of success of the sports-related objective associated with the at least one second entity of the plurality of sports-related entities based on a set of associated input parameters of the at least one second entity; and facilitating communication between the first entity and the at least one second entity based on the likelihood of success of the sports-related objective.

In some aspects, the techniques described herein relate to a method, further including: facilitating a contract between the first entity and the at least one second entity for the at least one second entity to provide the sports-related services to the first entity, and facilitating a transaction between the first entity and the at least one second entity.

In some aspects, the techniques described herein relate to a method, wherein the transaction is performed under rules of National Collegiate Athletics Association (NCAA) under Name, Image, and Likeness.

In some aspects, the techniques described herein relate to a method, wherein the transaction transfers currency from the first entity to the at least one second entity for training.

In some aspects, the techniques described herein relate to a method, wherein the plurality of input parameters includes location, available times, sport interests, experience, age, sex, athletic statistics, and athletic experience.

In some aspects, the techniques described herein relate to a method, wherein the athletic statistics are obtained from a third-party application or a third-party database.

In some aspects, the techniques described herein relate to a method, wherein the first entity is a collegiate athlete and the at least one second entity is a plurality of professional sports organizations.

In some aspects, the techniques described herein relate to a method, further including periodically performing a background check on the first entity and the at least one second entity and notifying all associated entities of changes in the background check.

In some aspects, the techniques described herein relate to one or more non-transitory computer-readable media storing computer-executable instructions that, when executed by at least one processor, perform a method of optimally connecting a first entity with at least one second entity over a communication network for providing sports-related services. The method includes obtaining entity data associated with the first entity, wherein the entity data includes a plurality of input parameters indicative of a sports profile of the first entity, obtaining a sports-related objective of the first entity; obtaining global entity data from a plurality of sports-related entities, comparing, by a machine learning algorithm trained on a history of sports-related data, the plurality of input parameters with the global entity data from the plurality of sports-related entities, determining a likelihood of success of the sports-related objective associated with the at least one second entity of the plurality of sports-related entities based on a set of associated input parameters of the at least one second entity, facilitating communication between the first entity and the at least one second entity based on the likelihood of success of the sports-related objective, and facilitating schedules and contracts between the first entity and the at least one second entity.

In some aspects, the techniques described herein relate to a media, wherein the first entity is a parent of child athlete, and the schedules and the contracts include signing the child athlete up for a training session with the at least one second entity and paying an associated cost for the training session.

In some aspects, the techniques described herein relate to a media, wherein the at least one second entity is a student athlete and the associated cost for the training session is paid according to Name, Image, and Likeness rules associated with the student athlete.

In some aspects, the techniques described herein relate to a media, wherein the first entity is a professional athlete and the at least one second entity includes a professional sports organization and a third-party company, and wherein the schedules and the contracts include a first payment for playing for the professional sports organization and a second payment for marketing a brand of the third-party company.

In some aspects, the techniques described herein relate to one or more non-transitory computer-readable media storing computer-executable instructions that, when executed by at least one processor, perform a method of optimally connecting a first entity with at least one second entity over a communication network for providing sports-related services. The method includes obtaining first entity data associated with the first entity, wherein the first entity data includes a first plurality of input parameters indicative of a sports profile of the first entity, obtaining second entity data associated with a second entity, wherein the second entity data includes a second plurality of input parameters indicative of a sports-related service; obtaining global entity data from a plurality of sports-related entities, comparing the first plurality of input parameters, the second plurality of input parameters, and the global entity data from the plurality of sports-related entities, matching the first entity with the second entity based on the comparing, wherein the first entity data includes financial information of the first entity, and facilitating a transaction between the first entity and the second entity for the sports-related service.

In some aspects, the techniques described herein relate to a media, wherein the first entity is an athlete, and the second entity is a sports team.

In some aspects, the techniques described herein relate to a media, wherein the facilitating includes: receiving an input by a user interface associated with the first entity to transfer funds from a first entity account to a second entity account; and transferring the funds from the first entity account to the second entity account.

In some aspects, the techniques described herein relate to a media, wherein the facilitating includes receiving an input by a user interface associated with the first entity to transfer funds from a first entity account to a second entity account; and sending a request to a third party to transfer the funds.

In some aspects, the techniques described herein relate to a media, wherein the funds include non-fungible tokens, cryptocurrency, or investments.

In some aspects, the techniques described herein relate to a media, wherein the method further includes facilitating a loan for the first entity based on the first entity data.

In some aspects, the techniques described herein relate to a media, wherein the financial information includes a credit report of the first entity, and wherein the facilitating includes transferring funds from a first entity account to a second entity account based on the credit report of the first entity.

In some aspects, the techniques described herein relate to a media, wherein the comparing is performed by a machine learning algorithm, and wherein the method further includes reducing, using a feature selection process, a first dimension of the first entity data to generate the first plurality of input parameters and a second dimension of the second entity data to generate the second plurality of input parameters to reduce processing in the comparing of a predictive phase of the machine learning algorithm.

In some aspects, the techniques described herein relate to one or more non-transitory computer-readable media storing computer-executable instructions that, when executed by at least one processor, perform a method of optimally connecting a first entity with at least one second entity over a communication network for providing sports-related services. The method includes obtaining first entity data associated with the first entity, wherein the first entity data includes a first plurality of input parameters indicative of a sports profile of the first entity, obtaining second entity data associated with a second entity, wherein the second entity data includes a second plurality of input parameters indicative of a sports-related service, obtaining global entity data from a plurality of sports-related entities, comparing, by a machine learning algorithm trained on a history of sports-related data, the first plurality of input parameters, the second plurality of input parameters, and the global entity data from the plurality of sports-related entities, matching the first entity with the second entity based on the comparing, wherein the first entity data includes financial information of the first entity, automatically scheduling an activity between the first entity and the second entity, and automatically facilitating a transaction between the first entity and the second entity for the activity.

In some aspects, the techniques described herein relate to a media, wherein the facilitating includes receiving an input by a user interface associated with the first entity to transfer funds from a first entity account to a second entity account, and transferring the funds from the first entity account to the second entity account.

In some aspects, the techniques described herein relate to a media, wherein the funds include non-fungible tokens, cryptocurrency, or investments.

In some aspects, the techniques described herein relate to a media, wherein the method further includes facilitating a loan for the first entity based on the first entity data.

In some aspects, the techniques described herein relate to a media, wherein the financial information includes a credit report of the first entity, and wherein the facilitating includes transferring funds from a first entity account to a second entity account based on the credit report of the first entity.

In some aspects, the techniques described herein relate to a media, wherein the method further includes reducing, using a feature selection process, a first dimension of the first entity data to generate the first plurality of input parameters and a second dimension of the second entity data to generate the second plurality of input parameters to reduce processing in the comparing of a predictive phase of the machine learning algorithm.

In some aspects, the techniques described herein relate to a system for optimally connecting a first entity with at least one second entity over a communication network for providing sports-related services, the system including a data store, at least one processor, and one or more non-transitory computer-readable media storing computer-executable instructions that, when executed by the at least one processor, perform a method of optimally connecting the first entity with the at least one second entity over the communication network for providing the sports-related services, the method including obtaining first entity data associated with the first entity, wherein the first entity data includes a first plurality of input parameters indicative of a sports profile of the first entity; obtaining second entity data associated with a second entity, wherein the second entity data includes a second plurality of input parameters indicative of a sports-related service, obtaining global entity data from a plurality of sports-related entities, comparing, by a machine learning algorithm trained on a history of sports-related data, the first plurality of input parameters, the second plurality of input parameters, and the global entity data from the plurality of sports-related entities, matching the first entity with the second entity based on the comparing, wherein the first entity data includes financial information of the first entity, automatically scheduling an activity between the first entity and the second entity, and automatically facilitating a transaction between the first entity and the second entity for the activity, wherein the transaction is based on a credit of the first entity and is associated with a first entity account at a third-party financial institution.

In some aspects, the techniques described herein relate to a system, wherein the first entity is an athlete, and the second entity is a trainer, and wherein the activity is a training session and the transaction is payment for the training session.

In some aspects, the techniques described herein relate to a system, wherein the facilitating includes receiving an input by a user interface associated with the first entity to transfer funds from the first entity account to a second entity account, and transferring the funds from the first entity account to the second entity account.

In some aspects, the techniques described herein relate to a system, wherein the funds include non-fungible tokens, cryptocurrency, or investments.

In some aspects, the techniques described herein relate to a system, wherein the method further includes facilitating a loan for the first entity based on the first entity data.

In some aspects, the techniques described herein relate to a system, wherein the facilitating the transaction includes transferring funds from the first entity account to a second entity account based on the credit of the first entity and receiving the funds from the third-party financial institution to cover an amount of the funds transferred.

Although the invention has been described with reference to the embodiments illustrated in the attached drawing figures, it is noted that equivalents may be employed, and substitutions made herein without departing from the scope of the invention.

Having thus described various embodiments of the disclosure, what is claimed as new and desired to be protected by Letters Patent includes the following:

1. One or more non-transitory computer-readable media storing computer-executable instructions that, when executed by at least one processor, perform a method of optimally connecting a first entity with at least one second entity over a communication network for providing sports-related services, the method comprising:
obtaining first entity data associated with the first entity,
wherein the first entity data comprises a first plurality of input parameters indicative of a sports profile of the first entity;
obtaining second entity data associated with a second entity,
wherein the second entity data comprises a second plurality of input parameters indicative of a sports-related service;
obtaining global entity data from a plurality of sports-related entities;
comparing the first plurality of input parameters, the second plurality of input parameters, and the global entity data from the plurality of sports-related entities;
matching the first entity with the second entity based on the comparing;
wherein the first entity data comprises financial information of the first entity; and
facilitating a transaction between the first entity and the second entity for the sports-related service.

2. The media of claim 1, wherein the first entity is an athlete, and the second entity is a sports team.

3. The media of claim 1, wherein the facilitating comprises:
receiving an input by a user interface associated with the first entity to transfer funds from a first entity account to a second entity account; and
transferring the funds from the first entity account to the second entity account.

4. The media of claim 1, wherein the facilitating comprises:
receiving an input by a user interface associated with the first entity to transfer funds from a first entity account to a second entity account; and
sending a request to a third party to transfer the funds.

5. The media of claim 4, wherein the funds comprise non-fungible tokens, cryptocurrency, or investments.

6. The media of claim 1, wherein the method further comprises facilitating a loan for the first entity based on the first entity data.

7. The media of claim 1,
wherein the financial information includes a credit report of the first entity, and
wherein the facilitating comprises:
transferring funds from a first entity account to a second entity account based on the credit report of the first entity.

8. The media of claim 1,
wherein the comparing is performed by a machine learning algorithm, and
wherein the method further comprises reducing, using a feature selection process, a first dimension of the first entity data to generate the first plurality of input parameters and a second dimension of the second entity data to generate the second plurality of input parameters to reduce processing in the comparing of a predictive phase of the machine learning algorithm.

9. One or more non-transitory computer-readable media storing computer-executable instructions that, when executed by at least one processor, perform a method of optimally connecting a first entity with at least one second entity over a communication network for providing sports-related services, the method comprising:
obtaining first entity data associated with the first entity,
wherein the first entity data comprises a first plurality of input parameters indicative of a sports profile of the first entity;
obtaining second entity data associated with a second entity,
wherein the second entity data comprises a second plurality of input parameters indicative of a sports-related service;
obtaining global entity data from a plurality of sports-related entities;
comparing, by a machine learning algorithm trained on a history of sports-related data, the first plurality of input parameters, the second plurality of input parameters, and the global entity data from the plurality of sports-related entities;
matching the first entity with the second entity based on the comparing;
wherein the first entity data comprises financial information of the first entity;
automatically scheduling an activity between the first entity and the second entity; and
automatically facilitating a transaction between the first entity and the second entity for the activity.

10. The media of claim 9, wherein the facilitating comprises:
receiving an input by a user interface associated with the first entity to transfer funds from a first entity account to a second entity account; and
transferring the funds from the first entity account to the second entity account.

11. The media of claim 10, wherein the funds comprise non-fungible tokens, cryptocurrency, or investments.

12. The media of claim 9, wherein the method further comprises facilitating a loan for the first entity based on the first entity data.

13. The media of claim 9,
wherein the financial information includes a credit report of the first entity, and
wherein the facilitating comprises:
transferring funds from a first entity account to a second entity account based on the credit report of the first entity.

14. The media of claim 9, wherein the method further comprises reducing, using a feature selection process, a first dimension of the first entity data to generate the first plurality of input parameters and a second dimension of the second entity data to generate the second plurality of input parameters to reduce processing in the comparing of a predictive phase of the machine learning algorithm.

15. A system for optimally connecting a first entity with at least one second entity over a communication network for providing sports-related services, the system comprising:
a data store;
at least one processor; and
one or more non-transitory computer-readable media storing computer-executable instructions that, when executed by the at least one processor, perform a method of optimally connecting the first entity with the at least one second entity over the communication network for providing the sports-related services, the method comprising:
obtaining first entity data associated with the first entity,
wherein the first entity data comprises a first plurality of input parameters indicative of a sports profile of the first entity;
obtaining second entity data associated with a second entity,
wherein the second entity data comprises a second plurality of input parameters indicative of a sports-related service;
obtaining global entity data from a plurality of sports-related entities;
comparing, by a machine learning algorithm trained on a history of sports-related data, the first plurality of input parameters, the second plurality of input parameters, and the global entity data from the plurality of sports-related entities;
matching the first entity with the second entity based on the comparing;
wherein the first entity data comprises financial information of the first entity;
automatically scheduling an activity between the first entity and the second entity; and
automatically facilitating a transaction between the first entity and the second entity for the activity,
wherein the transaction is based on a credit of the first entity and is associated with a first entity account at a third-party financial institution.

16. The system of claim 15,
wherein the first entity is an athlete, and the second entity is a trainer, and
wherein the activity is a training session and the transaction is payment for the training session.

17. The system of claim 15, wherein the facilitating comprises:
receiving an input by a user interface associated with the first entity to transfer funds from the first entity account to a second entity account; and
transferring the funds from the first entity account to the second entity account.

18. The system of claim 17, wherein the funds comprise non-fungible tokens, cryptocurrency, or investments.

19. The system of claim 15, wherein the method further comprises facilitating a loan for the first entity based on the first entity data.

20. The system of claim 15, wherein the facilitating the transaction comprises transferring funds from the first entity account to a second entity account based on the credit of the first entity and receiving the funds from the third-party financial institution to cover an amount of the funds transferred.
